(19) United States
(12) Patent Application Publication
(10) Pub. No.: US 2003/0035924 A1
(43) Pub. Date: Feb. 20, 2003

(54) Rigid laminated material

(75) Inventors: Coral A. Petit-Roberts, Lincoln, RI (US); Samuel K. Roberts, Lincoln, RI (US); Sterling L. Pelfrey, Duluth, GA (US)

Correspondence Address: Bradley Arant Rose & White LLP, Suite 1400, 2001 Park Place, Birmingham, AL, 35203-2736, US

(73) Assignee: Samuel K. Roberts

(21) Appl. No.: 09/931,978

(22) Filed: Aug. 17, 2001

(51) Int. Cl. B32B 3/10

(52) U.S. Cl. 428/137; 428/131; 428/174

(57) ABSTRACT

A rigid laminated material to be used primarily in kitchen and bathroom countertops and back splashes. The invention comprises a two-sided, heat deformable laminate, such as acrylic, that has raised peripheral portions on its reverse side. Reinforcing material such as liquid resin can be poured into the reverse side to self-bond with the laminate and is contained by the raised edges and allowed to harden.

### BACKGROUND

This invention relates generally to rigid laminated material and other reinforced surfaces often used in household applications, such as countertops and back splashes that are installed in bathrooms and kitchens.

There currently exist several methods for manufacturing rigid laminated materials such as countertops. Many countertops currently in use have two or more layers. There is often a top layer, or laminate, which is often made of material, such as acrylic or thermoplastic, and provides a smooth, attractive finish and serves as the functional surface for use by an individual. It is also common to apply to the underside of the laminate layer at least one additional layer of reinforcing material in order to give strength and durability to the laminate layer. This underlayer is often made of reinforcing materials, such as wood particulate, fiberglass-polyester or resin foam.

Application of the reinforcing material presents a number of challenges to the manufacturers of countertops. For instance, it is common to attempt to spray reinforcing material onto the underside of the laminate layer. This method can be cumbersome and imprecise and leads to the loss of large amounts of excess reinforcing material. The excess material is usually disposed of, resulting in waste. Even if it is possible to recycle the excess reinforcing material, time must be spent to recover and treat the excess material to permit its reuse.

Other methods have been developed for the application of reinforcing materials to the underside of the laminate. These methods often vary depending on the type of laminate and reinforcing materials being used and on the manner in which the laminate and reinforcing materials are to be bonded together. Examples of such methods are disclosed in Fay, U.S. Pat. No. 4,053,545 and Mulcahy, U.S. Pat. No. 5,601,679. Fay discloses the application of a foamable polymer reinforcing material to a thermoplastic sheet. Fay utilizes an injection molding system to combine the reinforcing material and the thermoplastic sheet. Further, according to Fay, the materials must be placed in an adaptable support mold and are also heated to applicable temperatures in order to achieve interfacial melting between the reinforcing material and the thermoplastic sheet. In addition, Fay discloses that adhesives must sometimes be used to supplement the bonding process.

One object of the present invention is to simplify the application of the reinforcing material to the laminate as, for instance, by eliminating the need to utilize mold injection during the application of the reinforcing material. This not only reduces production costs, the elimination of the use of molds from the application process facilitates increased output because production is not limited by the number of molds available. Another object of the invention is to allow for self-bonding of the reinforcing material to the laminate without requiring heat, pressure or adhesives. A further object of the invention is to provide for an economical means of applying the underlayer which is less labor intensive and minimizes loss of raw materials or the need to recycle excess material.

### SUMMARY

These and other objects and advantages are obtained in an invention comprising a two-sided laminate that provides a generally flat, top surface. The reverse side of the laminate layer is pan-like for containment of self-bonding reinforcing materials to be applied within the reverse side of the laminate in ambient conditions. Although the field of application of the present invention includes providing a wide variety of surfaces, it is anticipated that the present invention will find its most widespread use in connection with countertops and back splashes to be installed in bathrooms and kitchens.

### DESCRIPTION OF THE DRAWINGS

These and other features, aspects and advantages of the present invention will become better understood with reference to the following description, appended claims, and accompanying drawings where:

FIG. 1 is a three-dimensional perspective view oriented to show the reverse side of the two-sided laminate having a conical indentation;

FIG. 2 is a three-dimensional perspective view oriented to show the reverse side of the two-sided laminate filled with reinforcing material;

FIG. 3 is a three-dimensional perspective view oriented to show the reverse side of the two-sided laminate once the top portion of the conical indentation has ben removed;

FIG. 4 is a sectional view along reference line 4-4.

### DESCRIPTION

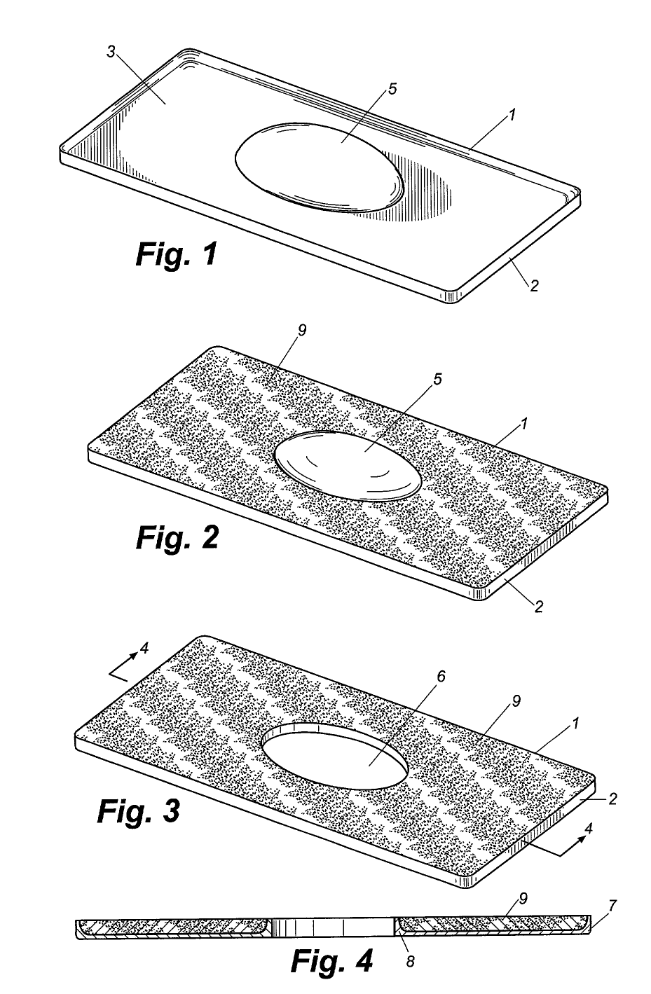

Referring to FIGS. 1, 2 and 3, the present invention is illustrated. The invention comprises a heat-deformable laminate 1 of at least two sides that will provide the top surface of the finished product. The laminate can be made of various kinds of materials, but it will be understood by those skilled in the art that a durable material having a smooth finish, such as acrylic, should be used to achieve optimal results in countertop and other applications.

In the preferred embodiment, a sheet of acrylic material is heated to an appropriate temperature and then configured by vacuum or other means into a laminate having a substantially planar top side (not shown) and peripheral portions 2 that extend down from said top side. It will be appreciated that when formed, the reverse side of the laminate comprises a pan-like sunken portion 3 having a continuous raised perimeter 2 capable of retaining liquid material poured therein. It is anticipated that the peripheral portions can be curved, curled or angled in downward fashion.

Once the laminate is formed, the pan-like portion which comprises the reverse side of the laminate is filled with reinforcing material 9 such as pourable liquid resin, urethane or polymer. In the preferred embodiment, the reinforcing material 9 is self-bonding to the underside of the laminate such that adhesives are not required. It will be appreciated that utilizing a liquid form promotes an even and uniform distribution of the reinforcing material and avoids waste. It is, however, also possible to apply other forms of reinforcing material, such as sprayed mixtures of resin, filler, catalyst and fiberglass roving. It will be appreciated that the reinforcing material poured into the reverse side of the laminate surface is contained by the raised perimeter 2 which permits the reinforcing material to settle, thus forming a substantially flat surface which serves as the bottom of the finished article. Once cured, the reinforcing material may be sanded or deburred to smooth or polish its surface.

In one alternative embodiment of the invention designed to accommodate a sink or other plumbing fixtures, one or more openings of appropriate shape to admit the sink or fixture is created within the laminate surface. This can be accomplished by heating the acrylic sheet to an appropriate temperature and then using vacuum means applied to the reverse side to form a conical (or dome-like) indentation 5 within the interior of the laminate. Referring to FIG. 2, once the laminate cools, the pan-like portion which comprises the reverse side of the laminate is filled with reinforcing material 9 to the maximum level of the continuous raised perimeter 2 and below the top of the conical indentation 5. After the reinforcing material 9 has hardened, the top portion of the conical indentation 5 is removed, usually by trimming, at or slightly above the plane of the hardened reinforcing material 9. Referring now to FIG. 3, it will be appreciated that removing the top portion of the conical indentation 5 will leave an opening 6 within the interior of the laminate. So fashioned, the reverse side of the laminate in the alternative embodiment will be bounded on its outer perimeter by a continuous raised portion 7 and also on its interior perimeter, which is defined by the opening, by a continuous raised portion 8. The outer and interior peripheral portions act to confine the reinforcing material as it is poured into the reverse side of the laminate. It is anticipated that a plurality of openings of various sizes and shapes, to accommodate faucets and other plumbing fixtures, can similarly be created within the confines of the laminate. It will further be appreciated that there are other means by which to create openings in the laminate.

Although the present invention has been described in considerable detail with reference to certain preferred embodiments thereof, other versions are possible. For example, in an alternative embodiment, a temporary dam or other like structure can be used to provide a temporary raised edge in those situations where it is difficult or undesirable to configure the laminate with continuous raised portions at the perimeter of its reverse side or the perimeter of any opening formed therein. It will be appreciated that the temporary dam can be placed at an unraised peripheral portion of the reverse side of the laminate surface to retain the reinforcing material that is poured into the reverse side. It will be appreciated that the temporary dam should be of a material that does not permit bonding with the reinforcing material. Once the reinforcing material is hardened, the temporary dam can easily be removed.

It will also be appreciated that the present invention can be used to manufacture back splashes and other like components used in connection with countertops. In such instances, where it is desired to produce a back splash that is mateable to a countertop, it is possible to locate a channel, slot or plurality thereof in the top side near one peripheral edge of said laminate. Said channel or slot can be sized to receive an appropriately sized ridge affixed to the bottom of a back splash.

Having described the basic concept of the present invention, it will be understood by those skilled in the art that the foregoing detailed disclosure is intended to be presented by way of example only, and is not limiting. Various alternations, improvements and changes will occur and are in the scope of the present invention. Accordingly, the present invention is limited only by the following claims and equivalents thereto. The spirit and scope of the appended claims should not be limited to the description of the preferred embodiments contained herein.

What is claimed is:

1. A rigid laminated material comprising:
(a) a two-sided laminate configured wherein the peripheral portions thereof border a pan-like sunken portion on a side thereof; and
(b) reinforcing material self-bonded to said laminate within said pan-like sunken portion.

2. The rigid laminated material of claim 1 wherein said two-sided laminate has outer peripheral portions and interior peripheral portions bordering at least partially said pan-like sunken portions on a side thereof.

3. The rigid laminated material of claim 1, wherein the two-sided laminate comprises a substantially flat acrylic sheet that is configured by heating and vacuum molding means.

4. A rigid laminated material comprising:
(a) a laminate having a top side and a reverse side, said reverse side comprising a pan-like sunken portion; and
(b) self-bonding reinforcing material poured into said pan-like sunken portion to bond thereto.

5. The rigid laminated material of claim 4 wherein the laminate has at least one interior opening within said laminate.

6. A rigid laminated material comprising:
(a) A laminate having a top side and a reverse side, said reverse side having raised edges; and
(b) self-bonding reinforcing material poured onto said reverse side and bounded by said raised edges.

7. The rigid laminated material of claim 6 wherein said laminate has at least one opening within the laminate interior, said opening having edges raised from said reverse side.

8. A method for producing a rigid laminated material, said method comprising the steps of:
(a) configuring a two-sided laminate so that the outer peripheral portions thereof border a pan-like sunken portion on a side thereof;
(b) placing self-bonding reinforcing material within said pan-like sunken portion; and
(c) curing said reinforcing material.

9. The method of claim 8, further comprising the step of configuring said two-sided laminate to have at least one interior opening, said opening having edges raised in the same direction as the outer peripheral portions.

10. The method of claim 9, wherein the step of configuring said openings comprises heating said laminate and shaping a conical indentation in said laminate and eliminating the portions of said conical indentation extending beyond the height of the cured reinforcing material.

11. The method of claim 8, further comprising the step of smoothing the surface of the cured reinforcing material.

12. The method of claim 8, wherein the step of forming the laminate comprises heating an acrylic sheet and forming it by vacuum means while heated.

13. The method of claim 8, further comprising the step of applying a temporary dam to bridge any gaps in the edges of said laminate sheet for containing the reinforcing material before said reinforcing material is cured.
